(19) United States
(12) Patent Application Publication
(10) Pub. No.: US 2011/0168275 A1
(43) Pub. Date: Jul. 14, 2011

(54) GAS IMPULSE BLOWER

(75) Inventor: Zvi Hadash, Kiryat Haim (IL)

(73) Assignee: H.Z. MANAGEMENT AND ENGINEERING SUPERVISION LTD., Kiryat Haim (IL)

(21) Appl. No.: 13/063,819

(22) PCT Filed: Sep. 16, 2009
(86) PCT No.: PCT/IL09/00907

§ 371 Date: Mar. 14, 2011

Related U.S. Application Data
(60) Provisional application No. 61/097,235, filed on Sep. 16, 2008.

(51) Int. Cl. B08B 5/02; B08B 13/00

(52) U.S. Cl. 137/15.01; 15/404

(57) ABSTRACT

A gas impulse blower for cleaning a surface within a vessel is fillable with a combustion gas-oxi-dizer mixture. The blower comprises: (a) a combustion assembly configured to generate a deflagration wave; and (b) an impulse generator having an inlet and an outlet and adapted to receive the deflagration wave into said inlet and eject the wave from said outlet onto a surface to be cleaned. The impulse generator has a compartmentalized housing comprising at least two serially-connected compartments. The compartments are configured for being fed with said gas-oxidizer mixture by the combustion assembly in an individual manner so as to conduct the wave to the outlet.

### FIELD OF THE INVENTION

The present invention relates to a gas impulse blower for removing soot, ash and slag deposits from the pipe surfaces in combustion equipments, and, more specifically, to a gas impulse blower provided with a compartmentalized impulse generator.

### BACKGROUND OF THE INVENTION

Proper maintenance of industrial machinery generally includes frequent removal of undesired accumulations of particles on different elements of the machinery. Particles accumulation on the machinery parts can be minimalized by cleaning the environment surrounding the machinery. Various air, steam, acoustic and vibration cleaning devices have been used for that purpose. Although a clean working environment reduces particle accumulation on the heat exchange surfaces, it cannot prevent such accumulation completely. Thus, more direct methods for cleaning the machinery parts are often required.

It is known that efficient cleaning of various machinery parts may be achieved by generating shock waves in the vicinity of the parts thereby blowing dust particles and other accumulations from the parts. Alternatively, the shock waves may be induced onto a machinery part, causing the part to vibrate and blow off the accumulations. Shock wave cleaning is particularly useful for elements which are not readily removed for cleaning and/or elements which are particularly susceptible to the use of other cleaning methods and/or cleaning materials.

Gas dynamic generators which induce shock wave vibrations in their vicinity are known in the art. When a gas dynamic generator is placed near a machinery element to be cleaned, the shock waves induced in the vicinity of the element can be utilized to clean the element, as described above. Gas dynamic generators are useful aids in the production of construction materials and apparatus, metallurgy, mining, the chemical industry, oil processing and the food industry.

During the operation of fossil fuel-fired equipments, especially, oil and coal-fired equipments, the combustion process produces soot and ash. Large boilers used in power generation plants and other industrial and commercial applications can produce especially large amounts of ash. The ash builds up on the heat exchanger tubes inside the boiler, which significantly reduces the heat transfer to the tubes and the thermal efficiency of the boiler. To maintain the desired efficiency of the boilers, boiler designers often install soot blowers which use media such as air or steam to clean specific areas of the boilers. However, in order to remove hard-to-clean deposits and/or deposits from not easily accessible areas of the boilers, operators often have to lower the load or capacity of the boiler and sometimes shut down the boiler. For example, electric utility companies sometimes schedule lowering of loads (derating) every night and/or schedule shutting down the boiler completely every few months or so, each shutdown typically lasting for a couple of days or so, to remove the ash deposits that have built up since the last shutdown. During the periods of derating, and shutdown of the boiler, the lost amount of electricity has to be purchased or obtained from other sources usually at higher prices.

A number of techniques have been developed to remove ash and soot deposits from boilers. One technique involves using retractable water, steam, or air jet equipment to attempt to spray and remove the ash and soot deposits off of the heat exchanger tubes. The thermal shock of the cooler water or other media can produce thermal stresses on the very hot metal heat exchanger tubes resulting in potential cracking and failures, and additional shutdowns for repairs. Another technique involves using shotguns, dynamite, or other explosives to attempt to jar the ash loose from the heat exchangers. But this technique can potentially damage the boiler and further, the boiler has to be shut down to insert the dynamite. And in yet another known technique, compressed air acoustic generators and pulse combustors are used to set up a standing acoustic wave to attempt to jolt the ash off the heat exchangers. But this approach has limited effectiveness because sound waves dissipate quickly and the loudness and frequencies needed to effectively remove the ash are harmful or at least very aggravating to the human ear.

Accordingly, what is needed but not found in the prior art is a way to remove soot and ash deposits from fuel-burning equipment in order to maintain a high availability and high thermal efficiency. In particular, there is a need for a system and method for removing the existing soot and ash deposits while the boiler is being operated and for not allowing ash and soot deposits to build up excessively any further on the heat exchangers, and thus minimizing any derating and loss of availability of the boiler. Furthermore, there is a need for such a system and method that is time- and cost-effective to build, install, operate, and maintain. It is to the provision of such an ash deposit removal system and method that the present invention is primarily directed.

U.S. Pat. No. 5,430,691 ('691) to Igor Friedman discloses a two-phase shock wave generator comprising a combustion chamber including (a) a first, combustion, portion having an input port and (b)a second; detonation, portion downstream of the first portion and having an output aperture; (c) an air-fuel supply line, operative to feed the input port with an air-fuel mixture, (d) an igniter, associated with the air-fuel supply line, which ignites the air-fuel mixture in the supply line and initiates a burning front which propagates towards the input port and (e) a turbulence stimulator, fixedly mounted in the combustion chamber, which enhances and controls burning of the air-fuel mixture and includes a first section, situated within the combustion portion of the combustion chamber and having a preselected first gas dynamic resistance and a second section, situated within the detonation portion of the combustion chamber and having a preselected second gas dynamic resistance, lower than the first resistance. The first resistance is such that burning of the air-fuel mixture in the combustion portion yields a predetermined pressure level suitable for initiating detonation of the remaining air-fuel mixture, in the detonation portion, and wherein the second resistance supports continued detonation of the remaining air-fuel mixture in the detonation portion.

In accordance with '691, a burning front propagates along the linear burning channel. The amplitude of the pressure impulse advancing inward to the target boiler is defined by the mass of air-fuel mixture accommodated in the detonation portion. The optimal detonation is related to a diameter/length ratio. To attain high amplitude detonation waves, large dimensions are required for the prior art detonation tubes. Thus, a unmet and long-felt need is to create a compact impulse detonation sootblower which nevertheless provides a sequence of pressure impulses of enhanced amplitude.

### SUMMARY OF THE INVENTION

It is hence one object of the invention to disclose a gas impulse blower for cleaning a surface within a vessel. The blower is finable with a combustion gas-oxidizer mixture. The blower comprising: (a) a combustion assembly configured to generate a deflagration wave; and (b) an impulse generator having an inlet and an outlet and adapted to receive the deflagration wave into the inlet and eject the wave from the outlet onto a surface to be cleaned.

It is a core purpose of the invention to provide the impulse generator has a compartmentalized housing comprising at least two serially-connected compartments. The compartments are configured for being fed with the gas-oxidizer mixture by the combustion assembly in an individual manner so as to conduct the wave to the outlet.

Another object of the invention is to disclose neighbouring compartments are serially-connected by means of at least one diaphragm-like turbulizer positioned within a division wall. The turbulizer is optionally off-centred.

A further object of the invention is to disclose the combustion assembly further comprising a source of a combustion gas, a source of an oxidizer, a mixer, and an igniter, and a conduit that is fillable with a gas-oxidizer mixture. The mixer is of a jet type.

A further object of the invention is to disclose the blower configured for being filled with a gas-oxidizer mixture and for igniting the mixture in a cyclical manner.

A further object of the invention is to disclose the combustion gas selected from the group consisting of hydrogen, acetylene, propane, butane, methane or any combination thereof.

A further object of the invention is to disclose the oxidizer selected from the group consisting of oxygen and air.

A further object of the invention is to disclose the outlet of the impulse generator provided with a cleaning head of a form selected from the group consisting of a tubular member, a perforated tubular member, a diffuser, a confuser, and any combination thereof.

A further object of the invention is to disclose the blower comprising a plurality of impulse generators arranged in parallel with one another and fed by the combustion assembly.

A further object of the invention is to disclose the blower comprising a manifold for facilitating fluid communication between said combustion assembly and said impulse generators.

A further object of the invention is to disclose the manifold configured to activate targeted impulse generators according a predetermined protocol.

A further object of the invention is to disclose the method of cleaning a surface within a vessel. The method comprising the steps of; (a) providing a gas impulse blower comprising (i) a combustion assembly configured to generate a deflagration wave; and (ii) an impulse generator having an inlet and an outlet and adapted to receive the deflagration wave into the inlet and eject the wave from the outlet to a surface to be cleaned; the impulse generator has a compartmentalized housing comprising at least two compartments; the compartments are configured for being fed with the gas-oxidizer mixture by the combustion assembly in an individual manner so as to conduct the wave to the outlet; (b) disposing the blower outlet into the space to be cleaned; (c) filling said blower with a combustion gas-oxidizer mixture; (d) producing the deflagration wave in the combustion assembly; (e) propagating the deflagration wave from the combustion assembly to the impulse generator; (f) detonating said gas-air mixture in the compartments of the impulse generator upon receiving of the deflagration wave; and (g) ejecting a detonation wave from the outlet to said vessel surface to be cleaned.

A further object of the invention is to disclose the step of filling the blower with said combustion gas-oxidizer mixture further comprising feeding a gas selected from the group consisting of hydrogen, acetylene, propane, butane, or any combination thereof into the device.

A further object of the invention is to disclose the step of filling the blower with said combustion gas-oxidizer mixture further comprising feeding an oxidizer selected from the group consisting of oxygen and air into said device.

A further object of the invention is to disclose the step of filling the blower with the combustion further comprising mixing the combustion gas and the oxidizer.

A further object of the invention is to disclose the step of creating the deflagration wave further comprising igniting the gas-oxidizer mixture by means of an igniter.

A further object of the invention is to disclose the deflagration wave propagating from the combustion assembly to the compartments of the impulse generator via individual passages leading to each of the compartments.

A further object of the invention is to disclose the step of detonating the gas-air mixture in the compartments is initiated by the deflagration wave provided individually to each compartment. The steps c-g are performed repeatedly.

A further object of the invention is to disclose the said steps of filling the blower with a combustion gas-oxidizer mixture and propagating the deflagration wave from the combustion assembly to the impulse generator performed using a manifold according to a predetermined protocol.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of the gas impulse blower;

FIG. 2 is a schematic diagram of the impulse generator;

FIG. 3 is a schematic diagram of the impulse generator provided with the perforated head;

FIG. 4 is a schematic diagram of the impulse generator provided with the diffuser head;

FIG. 5 is a schematic diagram of the impulse generator provided with the confuser head;

FIG. 6 is a schematic diagram of the impulse generator provided with the skewed head; and

FIG. 7 is a schematic diagram of the igniter.

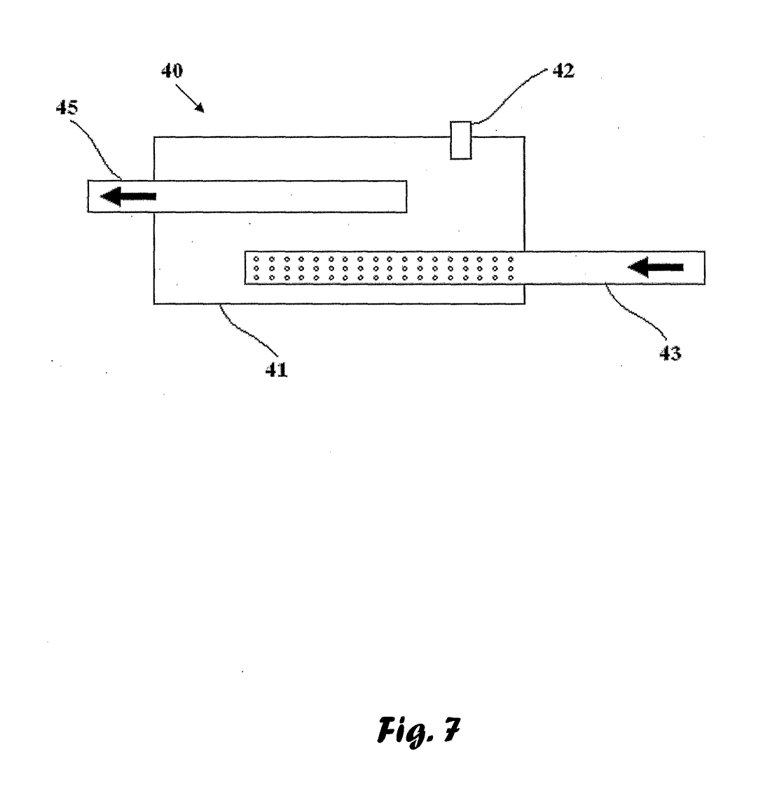

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide gas impulse blower for cleaning a surface within a vessel and method of using same.

The term ‘combustion or burning’ hereinafter refers to a complex sequence of exothermic chemical reactions between a fuel and an oxidant accompanied by the production of heat or both heat and light in the form of either a glow or flames. Direct combustion by atmospheric oxygen is a reaction mediated by radical intermediates. The conditions for radical production are naturally produced by thermal runaway, where the heat generated by combustion is necessary to maintain the high temperature necessary for radical production.

The term ‘detonation’ hereinafter refers to a process of supersonic combustion in which a shock wave is propagated forward due to energy release in a reaction zone behind it. It is the more powerful of the two general classes of combustion, the other one being deflagration. In a detonation, the shock compresses the material thus increasing the temperature to the point of ignition. The ignited material burns behind the shock and releases energy that supports the shock propagation. This self-sustained detonation wave is different from a deflagration, which propagates at a subsonic speed (i.e., slower than the sound speed of the explosive material itself), and without a shock or any significant pressure change. Because detonations generate high pressures, they are usually much more destructive than deflagrations. Detonations can be produced by high explosives, reactive gaseous mixtures, certain dusts and aerosols.

Deflagration to Detonation Transition (DDT) process can be divided into four phases:
(a) Deflagration initiation. A relatively weak energy source such as an electric spark is used to create a flame. The energy release from the initiator device along with radical production and energy release from the mixture compete with loss processes including expansion of the reacting flowfield and thermal conduction and species transport away from the flame front. Flammability limits which result from this competition have been extensively researched.
(b) Flame acceleration. Increasing energy release rate and the formation of strong shock waves are caused by flame acceleration.
(c) Formation and amplification of explosion centers. One or more localized explosion centers form as pockets of reactants reach critical ignition conditions (the so-called explosion within the explosion). Critical temperatures are typically around 1100 K and 1500 K for fuel-oxygen and fuel-air mixtures, respectively. The explosion centers create small blast waves which rapidly amplify in the surrounding mixture.
(d) Formation of a detonation wave. The amplified blast waves and existing shock-reaction zone complex merge into a supersonic detonation front which is self-sustaining.

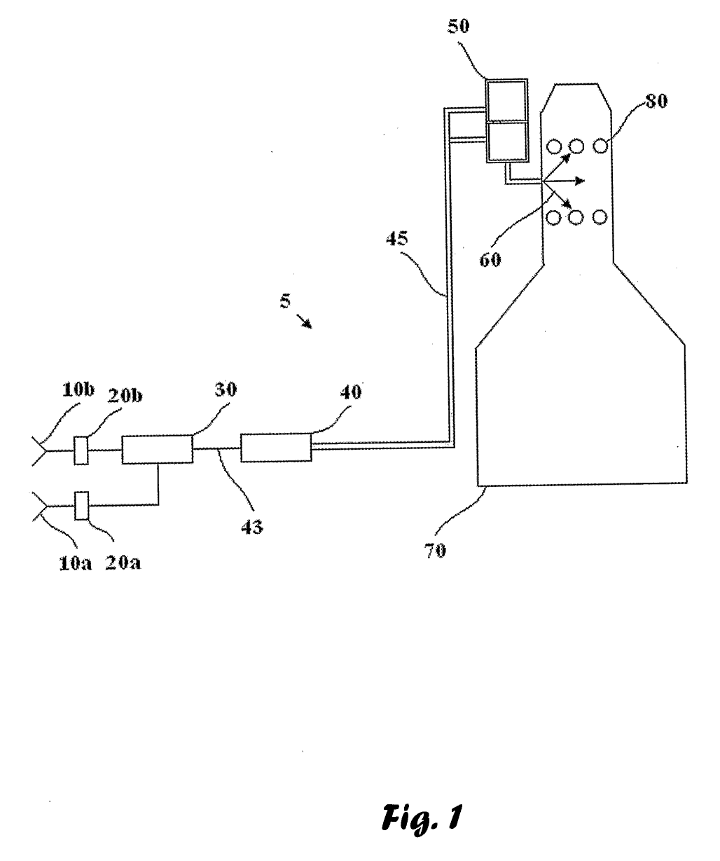

Reference is now made to FIG. 1, showing a schematic diagram of a proposed gas impulse blower 5 comprising a source of a combustion gas 10a, a source of an oxidizer 10b, valves 20a and 20b, adapted to control combustion gas and oxidizer flows, a mixer 30, an igniter 40, a tube 45, an impulse generator 50 fluidly connected to an interior of an industrial furnace 70. A shock wave 60 provided by the impulse generator 50 is directed to heat exchanger 80 to remove soot and ash deposits congested thereon. In accordance with the preferred embodiment of the current invention, the blower 5 provides a sequence of detonative impulses. The combustion gas and oxidizer provided by the sources 10a and 10b per valves 20a and 20b, respectively, are mixed in a predetermined ratio in the mixer 30. The obtained mixture is fed into the tube 45 and the impulse generator 50. An igniting impulse is applied to the igniter with a time delay enabling the combustion mixture to fill the tube 45 and impulse generator 50. When ignited, the combustion mixture forms a deflagration wave propagating with relatively low velocity. The deflagration process in the tube 45 does not result in significant rise of a tube wall temperature (up to 40° C.) due to high velocity of the periodical deflagration waves. The detonation wave is originated in the impulse generator. Thus, there is no high pressure in the deflagration tube 45 (a length of the tube 45 optionally reaches 200 m).

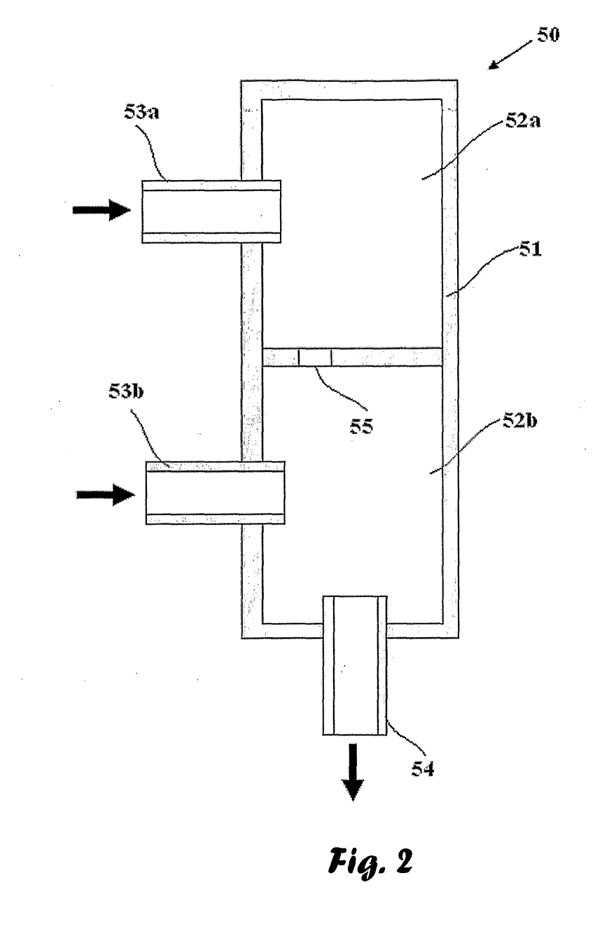

Reference is now made to FIG. 2, unlimitedly illustrating the impulse generator 50 in detail. According to the stated long-felt need, the proposed technical solution provides a greater power of an output detonation wave due to compartmentalization of the impulse generator 50. FIG. 2 presents two compartments 52a and 52b accommodated in a housing 51. The compartments 52a and 52b are individually fed with the combustion mixture per inlets 53a and 53b, respectively. A greater number of the aforesaid compartments is in the scope of the current invention. The compartments 52a and 52b are fluidly connected in series to an outlet 54 through a diaphragm-like turbulizer 55 optionally off-centered. The diaphragm-like turbulizer 55 is adapted for swirling the gas flow.

FIG. 2 shows a schematic diagram explaining an operating principle. Any configuration of the generator 50 (e.g. cylindrical, prismatic, parallelepiped or combination thereof) is also in the scope of the current invention. The simultaneous igniting the combustion mixture in the compartments 52a and 52b enhances the velocity of combustion process so that the aforesaid process passes in detonation providing a wave of supersonic velocity.

The compartments 52a and 52b are in parallel fed with the combustion mixture per the tube 45 (not shown) per the inlets 53a and 53b, respectively. After filling the aforesaid compartments 52a and 52b, the deflagration wave arrives thereat. An advantage provided by the proposed technical solution is in concurrently detonating the combustion mixture accommodated in both compartments 52a and 52b that provides a cumulative effect.

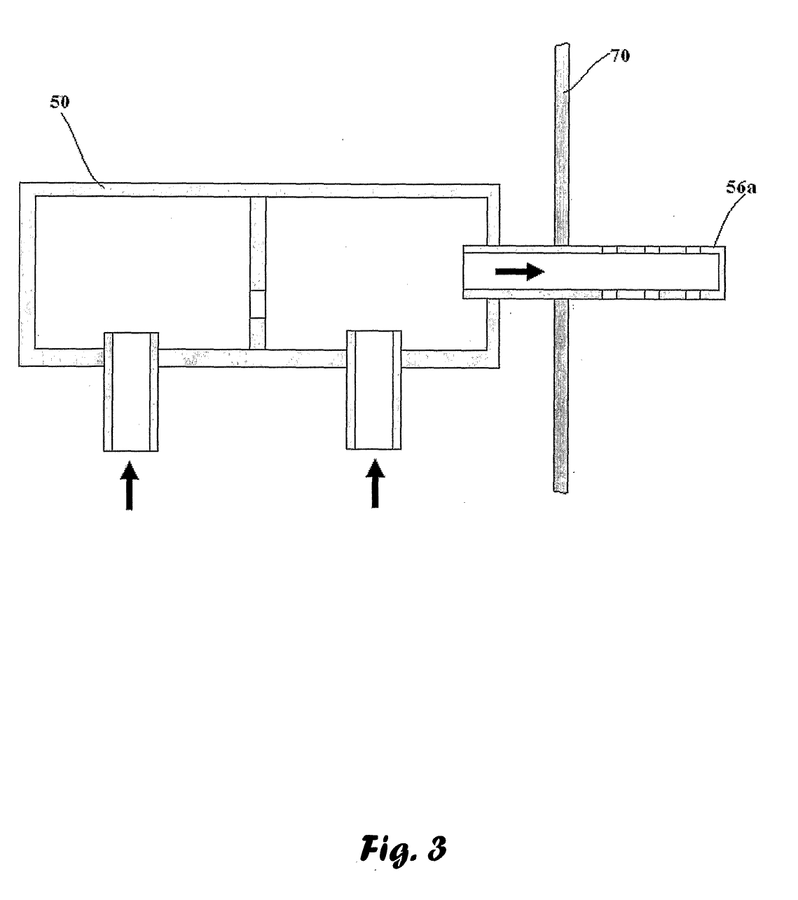

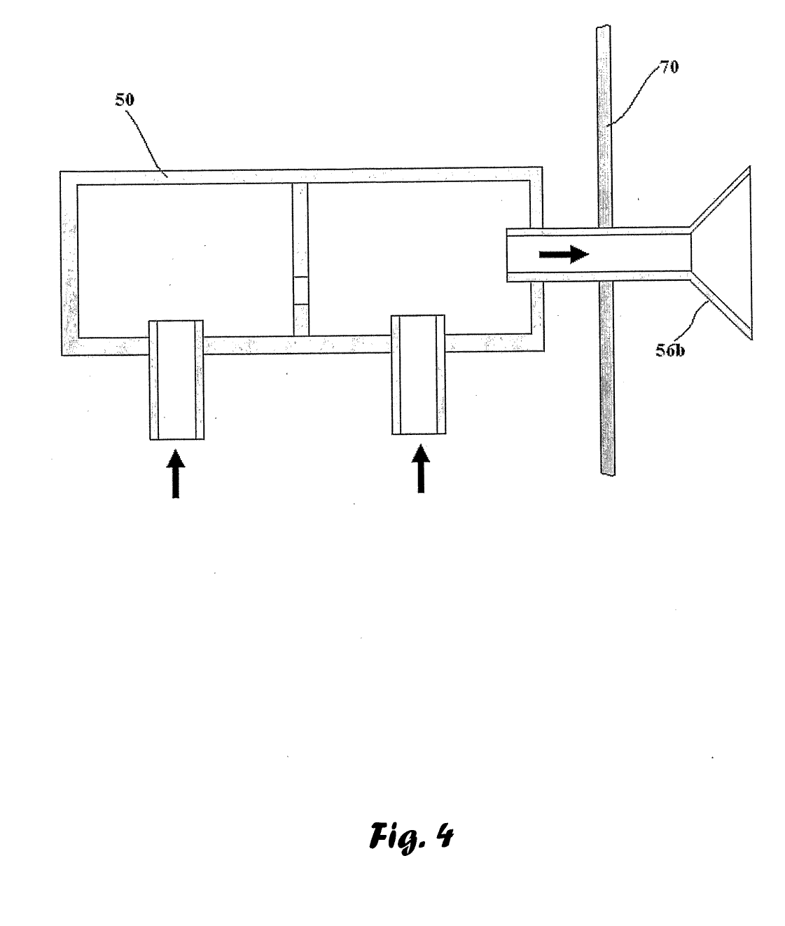

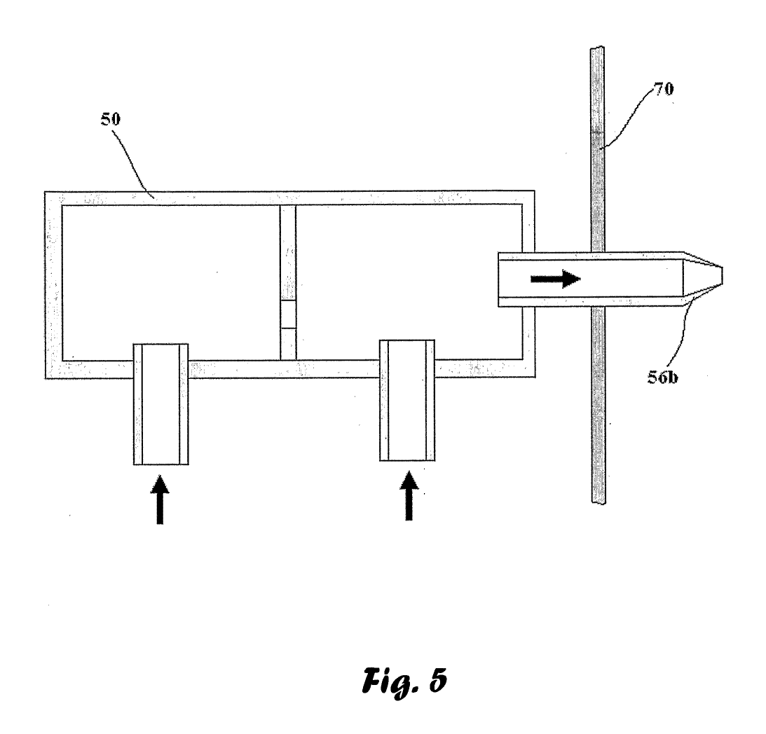

Reference is now made to FIGS. 3, 4, 5, and 6, presenting cleaning head of different form, specifically, perforated, diffuser, confuser, and skewed heads 56a, 56b, 56c, and 56d respectively. The aforesaid head are applicable according to a configuration of the cleaned surface. The abovementioned heads are designed for specific distributing the detonation wave in the inner space of the industrial furnace 70.

The proposed technical solution is applicable for cleaning furnaces, heaters, steam-generators or other fuel-burning equipments. Specifically, it can be used for cleaning Ljunstrom or Rothemuhle lamellar rotary regenerative air preheaters.

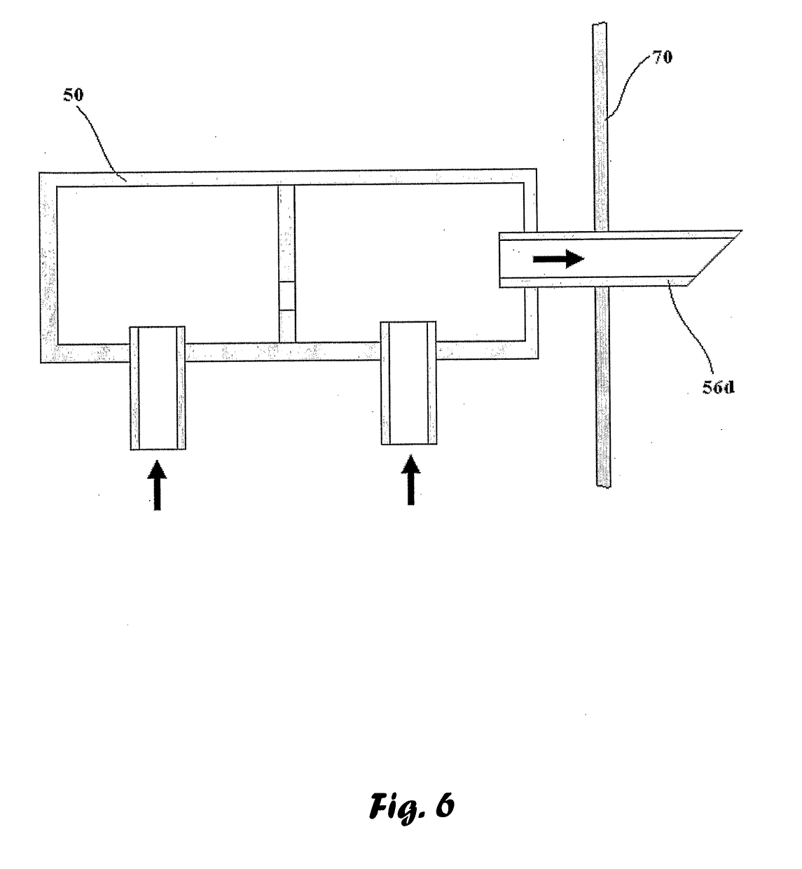

Reference is now made to FIG. 6, presenting a schematic diagram of the igniter 40 in detail. The igniter comprises a housing 41, a spark plug 42, a feed pipe 43, and a combustion tube 45. As said above, an igniting electrical impulse is provided to the plug 42 after filling all spaces of the blower 5 (not shown) with combustion. mixture. The steps of filling of the blower 5 with the combustion mixture and igniting the aforesaid mixture are performed repeatedly.

In accordance with one embodiment of the current invention, additional components are admixed into impulse gas flow. Specifically; admixing steam, mist, air is in the scope of the current invention. Injecting aforesaid admixing steam, mist, air allows results in temperature reduction of the cleaning head. Temperature reduction prevents the combustion mixture from self-ignition from the blower outlet.

In accordance with the current invention, a gas impulse blower for cleaning a surface within a vessel is fillable with a combustion gas-oxidizer mixture. The blower comprises: (a) a combustion assembly configured to generate a deflagration wave; and (b) an impulse generator having an inlet and an outlet and adapted to receive the deflagration wave into said inlet and eject the wave from said outlet onto a surface to be cleaned. The impulse generator has a compartmentalized housing comprising at least two serially-connected compartments. The compartments are configured for being fed with said gas-oxidizer mixture by the combustion assembly in an individual manner so as to conduct the wave to the outlet.

In accordance with another embodiment of the current invention, neighbouring compartments are serially- connected by means of at least one diaphragm-like turbulizer positioned within a division wall. The turbulizer is off-centred.

In accordance with a further embodiment of the current invention, combustion assembly further comprises a source of a combustion gas, a source of an oxidizer, a mixer, and an igniter, and a conduit that is fillable with a gas-oxidizer mixture. The mixer is of a jet type.

In accordance with a further embodiment of the current invention, the blower configured for being filled with a gas-oxidizer mixture and for igniting the mixture in a cyclical manner.

In accordance with a further embodiment of the current invention, the combustion gas is selected from the group consisting of hydrogen, acetylene, propane, butane, methane or any combination thereof.

In accordance with a further embodiment of the current invention, the oxidizer is selected from the group consisting of oxygen and air.

In accordance with a further embodiment of the current invention, the outlet of the impulse generator is provided with a cleaning head of a form selected from the group consisting of a tubular member, a perforated tubular member, a diffuser, a confuser, and any combination thereof.

In accordance with a further embodiment of the current invention, the blower comprises a plurality of impulse generators arranged in parallel with one another and fed by said combustion assembly.

In accordance with a further embodiment of the current invention, the blower comprises a manifold for facilitating fluid communication between the combustion assembly and the impulse generators.

In accordance with a further embodiment of the current invention, the manifold is configured to activate targeted impulse generators according a predetermined protocol.

In accordance with a further embodiment of the current invention, a method of cleaning a surface within a vessel comprises the steps of; (a) providing a gas impulse blower comprising (i) a combustion assembly configured to generate a deflagration wave; and (ii) an impulse generator having an inlet and an outlet and adapted to receive the deflagration wave into the inlet and eject the wave from the outlet to a surface to be cleaned; the impulse generator has a compartmentalized housing comprising at least two compartments; the compartments are configured for being fed with the gas-oxidizer mixture by the combustion assembly in an as individual manner so as to conduct the wave to the outlet; (b) disposing the blower outlet into the space to be cleaned; (c) filling the blower with a combustion gas-oxidizer mixture; (d) producing the deflagration wave in the combustion assembly; (e) propagating the deflagration wave from the combustion assembly to the impulse generator; (f) detonating a gas-air mixture in the compartments of the impulse generator upon receiving of the deflagration wave; and (g) ejecting a detonation wave from the outlet to the vessel surface to be cleaned.

In accordance with a further embodiment of the current invention, the step of filling the blower with the combustion gas-oxidizer mixture further comprises feeding a gas selected from the group consisting of hydrogen, acetylene, propane, butane, or any combination thereof into said device.

In accordance with a further embodiment of the current invention, the step of filling the blower with the combustion gas-oxidizer mixture further comprises feeding an oxidizer selected from the group consisting of oxygen and air into said device.

In accordance with a further embodiment of the current invention, the step of filling the blower with the combustion further comprises mixing the combustion gas and the oxidizer.

In accordance with a further embodiment of the current invention, the step of creating the deflagration wave further comprises igniting the gas-oxidizer mixture by means of an igniter.

In accordance with a further embodiment of the current invention, the deflagration wave propagates from the combustion assembly to the compartments of the impulse generator via individual passages leading to each of the compartments.

In accordance with a further embodiment of the current invention, the detonating the gas-air mixture in said compartments is initiated by the deflagration wave provided individually to each compartment. The steps c-g are performed repeatedly.

In accordance with a further embodiment of the current invention, the steps of filling the blower with a combustion gas-oxidizer mixture and propagating the deflagration wave from the combustion assembly to the impulse generator are performed using a manifold according to a predetermined protocol.

1-21. (canceled)

22. A gas impulse blower for cleaning a surface within a vessel, said blower is fillable with a combustion gas-oxidizer mixture, said blower comprising: (a) a combustion assembly configured to generate a deflagration wave; and (b) an impulse generator having an inlet and an outlet and adapted to receive said deflagration wave into said inlet and eject said wave from said outlet onto a surface to be cleaned; wherein said impulse generator has a compartmentalized housing comprising at least two serially-connected compartments, said compartments are configured for being fed with said gas-oxidizer mixture by said combustion assembly in an individual manner so as to conduct said wave to said outlet.

23. The blower according to claim 22, wherein neighbouring compartments are serially-connected by means of at least one diaphragm-like turbulizer positioned within a division wall.

24. The blower according to claim 22, wherein said combustion assembly further comprises a source of a combustion gas, a source of an oxidizer, a mixer, and an igniter, and a conduit that is fillable with a gas-oxidizer mixture.

25. The blower according to claim 24, wherein said mixer is of a jet type.

26. The blower according to claim 24, configured for being filled with a gas-oxidizer mixture and for igniting said mixture in a cyclical manner; further wherein said combustion gas is selected from the group consisting of hydrogen, acetylene, propane, butane, methane or any combination thereof; further wherein said oxidizer is selected from the group consisting of oxygen and air.

27. The blower according to claim 22, wherein said outlet of said impulse generator is provided with a cleaning head of a form selected from the group consisting of a tubular member, a perforated tubular member, a diffuser, a confuser, and any combination thereof.

28. The blower according to claim 22, wherein comprising a plurality of impulse generators arranged in parallel with one another and fed by said combustion assembly.

29. The blower according to claim 27, comprising a manifold for facilitating fluid communication between said combustion assembly and said impulse generators.

30. A method of cleaning a surface within a vessel; said method comprising the steps of;
(a) providing a gas impulse blower comprising (i) a combustion assembly configured to generate a deflagration wave; and (ii) an impulse generator having an inlet and an outlet and adapted to receive said deflagration wave into said inlet and eject said wave from said outlet to a surface to be cleaned; said impulse generator has a compartmentalized housing comprising at least two compartments; said compartments are configured for being fed with said gas-oxidizer mixture by said combustion assembly in an individual manner so as to conduct said wave to said outlet;
(b) disposing said blower outlet into said space to be cleaned;
(c) filling said blower with a combustion gas-oxidizer mixture;
(d) producing said deflagration wave in said combustion assembly;
(e) propagating said deflagration wave from said combustion assembly to said impulse generator;
(f) detonating a gas-air mixture in said compartments of said impulse generator upon receiving of said deflagration wave; and
(g) ejecting a detonation wave from said outlet to said vessel surface to be cleaned.

31. The method according to claim 10, wherein said step of filling said blower with said combustion gas-oxidizer mixture further comprises feeding a gas selected from the group consisting of hydrogen, acetylene, propane, butane, or any combination thereof into said device; further wherein said step of filling said blower with said combustion gas-oxidizer mixture further comprises feeding an oxidizer selected from the group consisting of oxygen and air into said device.

32. The method according to claim 30, wherein said step of filling said blower with said combustion further comprises mixing said combustion gas and said oxidizer.

33. The method according to claim 30, wherein said step of creating said deflagration wave further comprises igniting said gas-oxidizer mixture by means of an igniter.

34. The method according to claim 30, wherein said deflagration wave propagates from said combustion assembly to said compartments of said impulse generator via individual passages leading to each of said compartments; further wherein said detonating said gas-air mixture in said compartments is initiated by said deflagration wave provided individually to each compartment.

35. The method according to claim 30, wherein said steps c-g are performed repeatedly.

36. The method according to claim 30, wherein said steps of filling said blower with a combustion gas-oxidizer mixture and propagating said deflagration wave from said combustion assembly to said impulse generator are performed using a manifold according to a predetermined protocol.
